(19) United States
(12) Patent Application Publication
(10) Pub. No.: US 2021/0209589 A1
(43) Pub. Date: Jul. 8, 2021

(54) BLOCKCHAIN SESSION KEY

(71) Applicant: Infineon Technologies AG, Neubiberg (DE)

(72) Inventor: Wen Xin LEONG, Singapore (SG)

(21) Appl. No.: 17/140,488

(22) Filed: Jan. 4, 2021

(30) Foreign Application Priority Data
Jan. 7, 2020 (DE) 102020200070.0

(51) Int. Cl. G06Q 20/38; H04L 9/32; G06F 16/23; G06Q 20/36

(52) U.S. Cl. CPC G06Q 20/3825; H04L 9/3247; G06Q 2220/00; G06Q 20/3674; G06Q 20/3829; G06F 16/2379

(57) ABSTRACT

A method for signing a blockchain transaction comprises associating an associated key with a master key of a blockchain and generating, on behalf of the master key, a transaction for the blockchain using the associated key.

### RELATED APPLICATION

This application claims priority to German Patent Application No. 102020200070.0, filed on Jan. 7, 2020, entitled “Blockchain Session Key”, which is incorporated by reference herein in its entirety.

### SUMMARY

The present disclosure relates to methods and devices to be used in a blockchain system. The present disclosure further relates to a session-based blockchain key.

A blockchain key is commonly stored as a password encrypted file on a computer. To perform a transaction, the key may be loaded to a website or software, followed by password entry. Such an approach may not be secure. Therefore, hardware wallets are available to store the key in an isolated hardware. To access such a key, the user has to interact with the token to show user presence, e.g., to press the token's button. The preference for payment transaction seems reasonable, since it is not regular. However, when dealing with micro-transactions or autonomous machine-to-machine transactions (e.g., smart contract application or enterprise payment system) a user's presence is no longer viable.

Transactions related to payment and the named micro-transactions or autonomous machine-to-machine transactions may be based on signing information or data that describes the transaction with a key, e.g., to perform encryption or to verify a transaction by use of the signature. The result of such a step may be distributed within the blockchain system to announce the transaction made.

In accordance with the present disclosure, one or more methods and devices are provided that allow for a secure implementation of a block chain.

According to an embodiment, a method for signing a blockchain transaction comprises associating an associated key with a master key, wherein the master key is associated with a blockchain. The method further comprises generating, on behalf of the master key, a transaction for the blockchain using the associated key (so as to generate the transaction on behalf of the master key, for example).

According to an embodiment, a device configured to operate as a hot wallet device of a blockchain comprises a communication interface configured to receive a master key-based signature of an associated key associated with a master key of the blockchain. The device comprises a processor configured to generate, on behalf of the master key, a transaction of the blockchain using the associated key (so as to generate the transaction on behalf of the master key, for example). The device is configured to transmit the transaction to the blockchain.

According to an embodiment, a device configured to operate as a cold wallet device of a blockchain is provided. The device comprises a storage configured to store a master key of the blockchain (e.g., the master key is stored in the storage). The device comprises a processor configured to sign a key value with the master key to obtain a master key-based signature of the key value. The device comprises a communication interface configured to transmit the master key-based signature to a communication partner.

According to an embodiment, a blockchain system comprises at least one agent apparatus being implemented as a hot wallet device and at least one master key apparatus being implemented as a cold wallet device.

According to an embodiment, a blockchain system comprises one or more agent apparatuses and one or more master key apparatuses. A master key apparatus of the one or more master key apparatuses comprises a storage configured to store a master key of the blockchain, a processor configured to sign a key value with the master key to obtain a master key-based signature of the key value, and a communication interface configured to transmit the master key-based signature to a communication partner. An agent apparatus of the one or more agent apparatuses comprises a second communication interface configured to receive the master key-based signature of an associated key (e.g., the key value) associated with the master key of the blockchain. The agent apparatus comprises a second processor configured to generate, on behalf of the master key, a transaction of the blockchain using the associated key, wherein the agent apparatus is configured to transmit the transaction to the blockchain.

Further embodiments relate to a computer program and to a storage media having stored thereon machine-readable instructions for carrying out a method and/or one or more acts and/or operations in accordance with an embodiment when being executed by a computer.

Further embodiments are defined in the dependent claims.

### DESCRIPTION OF THE DRAWINGS

Example embodiments are described herein making reference to the appended drawings, in which:

FIG. 1 shows a schematic flowchart of a method for signing a blockchain transaction, according to an embodiment;

FIG. 2a shows a schematic block diagram showing the dependencies of keys to illustrate the result of the method of FIG. 1;

FIG. 2b shows a schematic block diagram of a combination of the master key and the associated key according to an embodiment;

FIG. 2c shows a schematic block diagram for illustrating the concept of signing of a transaction of a blockchain system on behalf of the master key according to an embodiment;

FIG. 3 shows a schematic flowchart of a method according to an embodiment, which may incorporate the method of FIG. 1;

FIG. 4 shows a schematic block diagram of a cold wallet device according to an embodiment;

FIG. 5 shows a schematic block diagram of a hot wallet device according to an embodiment;

FIG. 6 shows a schematic block diagram of a blockchain system according to an embodiment;

FIG. 7 shows a schematic block diagram illustrating a blockchain system according to an embodiment, comprising at least the device of FIG. 4 and the device of FIG. 5;

FIG. 8a shows a schematic block diagram of at least a part of a blockchain system according to an embodiment in which acts to generate the associated key and to generate the key policy are performed at the hot wallet device;

FIG. 8b shows a schematic block diagram of another part of the blockchain system of FIG. 8; and

FIG. 9 shows a schematic block diagram illustrating a relationship between a public key and a private key.

### DETAILED DESCRIPTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present disclosure. However, it will be apparent to those skilled in the art that embodiments of the present disclosure may be practiced without these specific details. In other instances, well known structures and devices are shown in block diagram form rather than in detail in order to avoid obscuring embodiments of the present disclosure. In addition, features of the different embodiments described hereinafter may be combined with each other, unless specifically noted otherwise.

In the following, reference is made to a blockchain, to a blockchain system, to devices for operating within a blockchain and to methods to be implemented within a blockchain. Blockchain may be used, for example, in connection with payment services, i.e., to transfer money. However, blockchain technology is not limited hereto but may also relate to micro-transactions or autonomous machine-to-machine transactions. Such transactions may relate to any kind of information that has to be securely acknowledged, e.g., smart contracts, proving a presence, e.g., so as to prove fulfillment of a working contract or the like, or simply to securely process a to-do list. A transaction may thus be considered as being an instruction. This may relate to a payment instruction, an operation instruction or the like. The transaction may be digitally signed to guarantee its integrity and authenticity.

Embodiments described herein relate to signing information, data or a transaction by use of a key. Thereby, signed information may be obtained. Embodiments may also relate to the attachment of additional information to such signed information, e.g., a key or the key used. However, although both, signing and adding additional information may be described whilst making reference to a generic term key, e.g., an associated key or a master key, embodiments are not limited to a use of exactly the same key. For example, although relating to a master key, signing performed therewith may be performed by use of a private part or private key of the master key when considering a public key/private key pair. Adding information may include attaching the public key part. For example, although relating to an associated key, signing performed therewith may be performed by use of a private part or private key of the associated key when considering a public key/private key pair. Adding information may include attaching the public key part of the associated key. For a better understanding, both, the private key and the public key may be referred to as master key, associated key respectively unless explicitly stated otherwise. However, embodiments are not limited to public key/private key pairs. For example, a common key may be used instead.

Embodiments described herein may relate to a hot wallet device and to a cold wallet device. One distinction between the two may that a hot wallet device may be connected to a network such as the internet, while a cold wallet may be kept offline. Therefore, information or funds stored in a hot wallet device may be much more accessible in comparison to information, data or funds in a cold wallet device. On the other hand, a cold wallet device may be more secure than a hot wallet device.

Whilst a hot wallet device may be more accessible, it may also be prone to hacking or being lost by accident. Therefore, a tradeoff may occur in view of security versus usability. For example, the more isolated a key is, the more the usability decreases whilst the security may increase. Alternatively and/or additionally, the less isolated a key is, the usability may increase whilst the security may decrease.

Embodiments provide for a good tradeoff between security and usability. Embodiments relate to generating an associated key (which may also be referred to as a session key) by using a master key which is to be protected. The associated key may be used for signing transactions of a blockchain. Since the session key (e.g., the associated key) is allowed to act on behalf of the master key as it is endorsed by the master key, this allows the master key to be stored in any suitable manner, e.g., in an isolated storage.

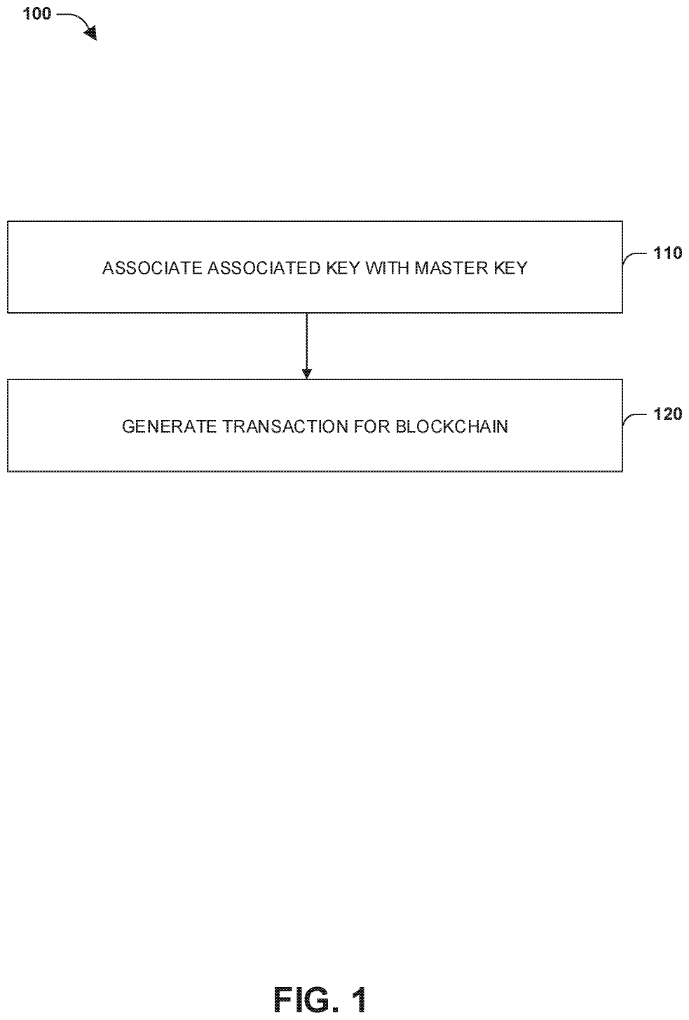

FIG. 1 shows a schematic flowchart of a method 100 for signing a blockchain transaction, according to an embodiment. In 110, an associated key is associated with a master key, wherein the master key is associated with the blockchain. That is, the master key is a key to be used in the blockchain, e.g., for signing transactions. For example, the master key may be associated with a wallet of the blockchain. The wallet may be a cold wallet device or a hot wallet device. In 120, a transaction for the blockchain is generated. Generating the transaction for the blockchain is performed using the associated key so as to generate the transaction on behalf of the master key.

The associated key may also be referred to as a session key, wherein a lifetime or a number of usages associated with the session key may be short/low or long/high. For example, the session key may remain valid until a termination thereof is reported or until actively the validity the key is invalidated. Alternatively and/or additionally, the lifetime or lifespan may be predefined.

According to an embodiment, a method comprises verifying a signature of the transaction using a blockchain-system so as to verify that the transaction was signed by use of the associated key. The method further comprises verifying a signature of the associated key so as to verify that the associated key was signed by use of the master key. After having successfully verified the signature of the associated key (and/or responsive to successful verification of the signature of the associated key), the transaction may be accepted as being made on behalf of the master key or a device associated with the master key. Accordingly, the transaction may be executed on behalf of the master's asset. According to an embodiment, the transaction may be evaluated, for example, by the blockchain system, for a key policy associated with the associated key. In some examples, the transaction may be analyzed to determine the key policy associated with the associated key. The transaction may be verified with respect to a compliance with the key policy, i.e., the transaction may be enabled. For example, while having determined that the transaction is made to an action going beyond the key policy, the transaction may be ignored or invalidated. In some examples, a termination event may be reported so as to allow to invalidate the associated key.

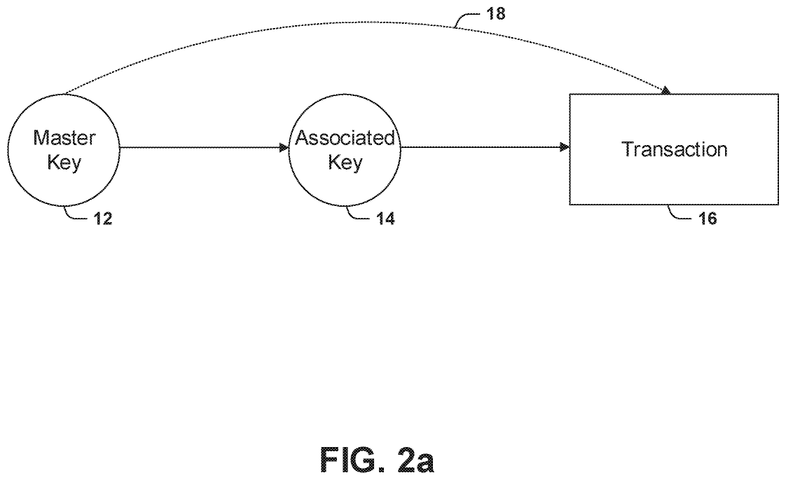

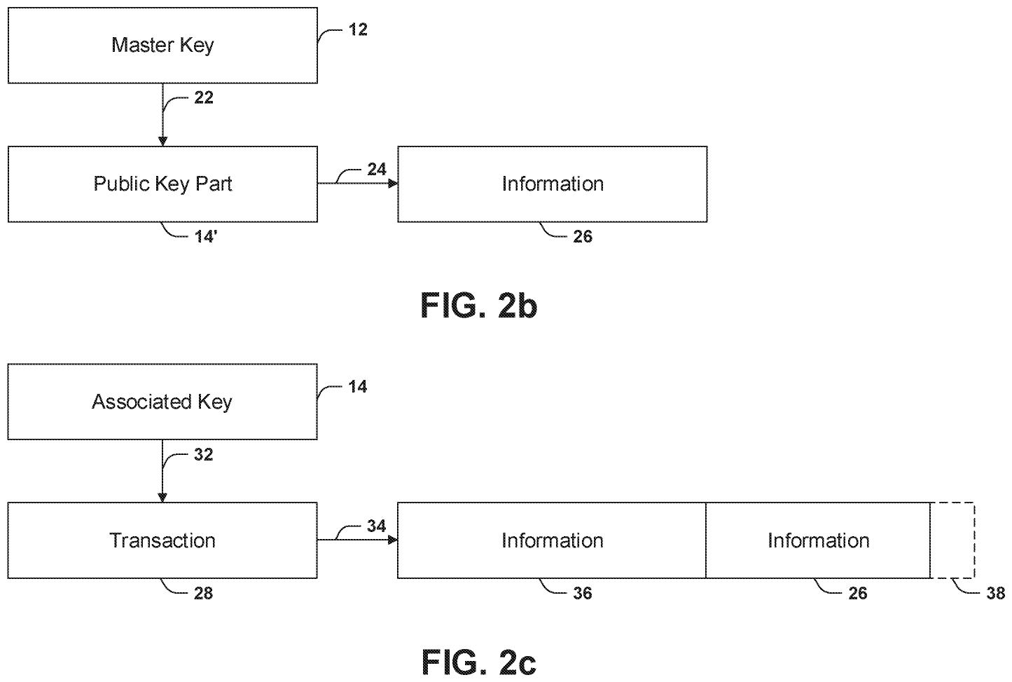

FIG. 2a is a schematic block diagram showing the dependencies of keys to illustrate an exemplary result of method 100.

A master key 12 of a blockchain is used to associate an associated key 14 with the master key 12. For example, a key value may be signed by use of the master key 12 so as to obtain a signed key value. The signed key value may indicate, within the blockchain system, that the master key was used to associate the key value 14 with the master key 12. Such information may be derived from the signed key value, e.g., by verifying the signature.

A transaction 16 of the blockchain may be signed and/or authorized by use of the associated key 14 such that, indirectly, the transaction 16 is generated on behalf of the master key 12 as indicated by authorization 18 of the transaction 16.

FIG. 2b shows a schematic block diagram of a combination of the master key 12 and the associated key 14, for example, a public key part 14′ of the associated key. By signing 22 the associated key 14 (and/or the public key part 14′) by use of the master key 12, information 26 may be obtained 24 which may be or comprise the associated key 14 (and/or the public key part 14′) being signed with the master key 12, i.e., a signed version of the associated key 14 or of the public part thereof. It is to be noted, that at the moment when the associated key 14 is generated, e.g., as a public key/private key pair, the key 14 may not yet be associated (with the master key 12, for example). For example, the association (of the associated key 14 with the master key 12, for example) may be implemented, in the blockchain system, by signing 22 the associated key 14 with the master key 12 and by publishing this information to the blockchain.

FIG. 2c shows a schematic block diagram illustrating the concept of signing of a transaction 28 of the blockchain system on behalf of the master key 12. The transaction 28 may be signed 32 by use of the associated key 14. For example, a private key part of the associated key 14 may be used to sign the transaction 28.

Embodiments provide for a method in which generating the transaction comprises signing information, e.g., information indicating a content of the transaction, using the associated key 14 to obtain 34 an associated key-based signature of the information, i.e., information 36. The method further comprises adding, to the associated key-based signature, a master key-based signature being obtained by signing the associated key using the master key.

According to an embodiment, devices are configured and/or methods are implemented to act on behalf of the master key and to further prove the endorsement of the associated key by providing for information at other entities to prove the endorsement, the acting on behalf of the master key. For example, information that identifies the master and that proves that the master has acknowledged or authorized the associated key may be provided. For example, by acting on behalf of the master key 12 and by providing information, e.g., by signing the transaction 28 by use of the associated key 14, information 36 may be obtained 34 which may comprise the obtained signature of transaction 28. However, this signing is based on the associated key 14 which might be, for example, any arbitrary value. For proving that the associated key 14 acts on behalf of the master key 12, information 26 may be included into the transaction as well as other information, for example, the master's public key. That is, information 26 may be obtained by use of the master's private key and to prove the association, the master key or, to allow for a high security, a public key part thereof, may be added. According to an embodiment, to the signed transaction 36 there may be added the public key part of the associated key 14 and the signed version 26 thereof, e.g., as information 38 (e.g., additional information) or as part thereof. In some examples, the master's public key may be added although the public key of a private key/public key pair may also be derived or recovered from the signature. In some examples, including the public key in a transaction may be omitted (e.g., the public key may not be included in the transaction) to save storage space.

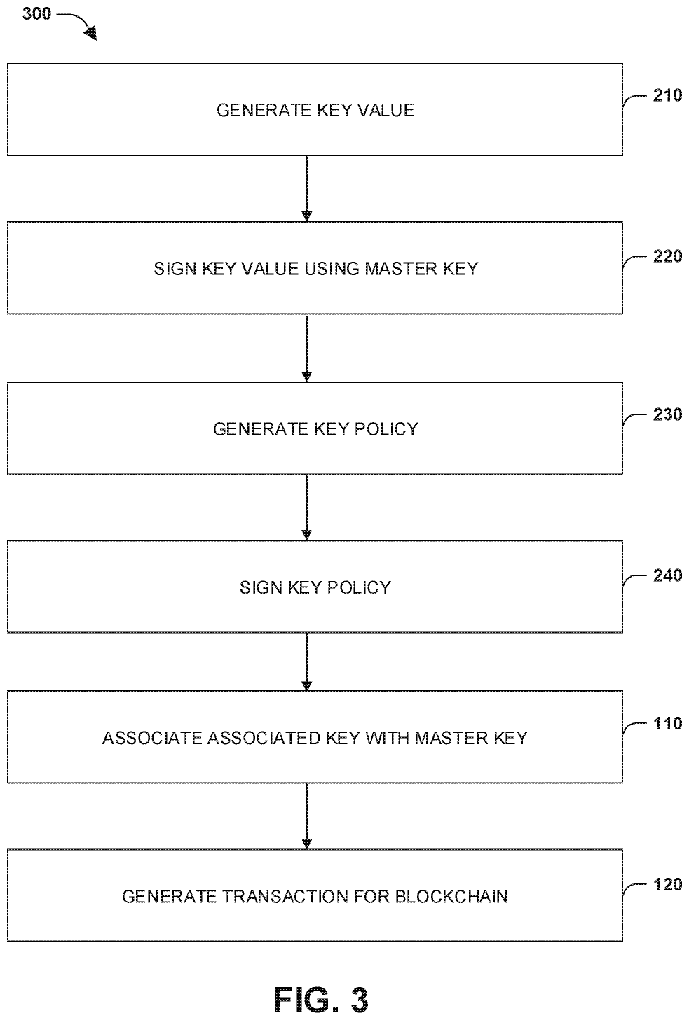

FIG. 3 shows a schematic flowchart of a method 300 according to an embodiment. Method 300 may incorporate method 100. In 210, a key value may be generated, for example, a public key value, e.g., key 14′ of FIG. 2b. In 220, the key value is signed using the master key so as to endorse the associated key by use of the master key. For example, information 26 may be obtained when implementing 220.

In some examples, method 300 may comprise an act 230 in which a key policy relating to a validity of the associated key is generated. Thereby a usability of the associated key 14 in the blockchain may be based on the key policy. The key policy may indicate, for example, a selection of at least a subset of transactions supported by the master key and/or a lifespan of the associated key. That is, the associated key may be linked with the key policy. As mentioned, a transaction may not only be related to a transfer of money but may indicate any type of information and/or action. For example, transactions supported by the master key may relate to a permission of performing specific actions, for example, read data, write data, manipulate data, open a lock of a door of a window, moving an object, starting an engine or any other kind of information. The key policy may indicate, that only a subset of all transactions supported by the blockchain are also supported by the session key. For example, access to one area may be granted using the associated key whilst access is unsupported for another area or the like. Alternatively or in addition, a lifespan of the associated key may be indicated in view of a time such as a time interval starting from a first use or starting from generation, a number of transactions to be signed with the associated key, e.g., in terms of a counter or the like.

In an act 240, the key policy generated in act 230 may be signed. For example, signing 240 may be implemented by use of the master key. Although signing 220 and signing 240 are illustrated as being two separate acts, both the acts may be implemented commonly and/or concurrently. It is noted that acts 230 and/or 240 may be performed prior to acts 210 and/or 220. Alternatively and/or additionally, acts 230 and/or 240 may be performed after acts 210 and/or 220. Method 300 further comprises acts 110 and 120.

Embodiments allow to sign the key value in a cold wallet device and to then generate and sign transactions in a hot wallet device whilst the master key remains securely stored in the cold wallet device.

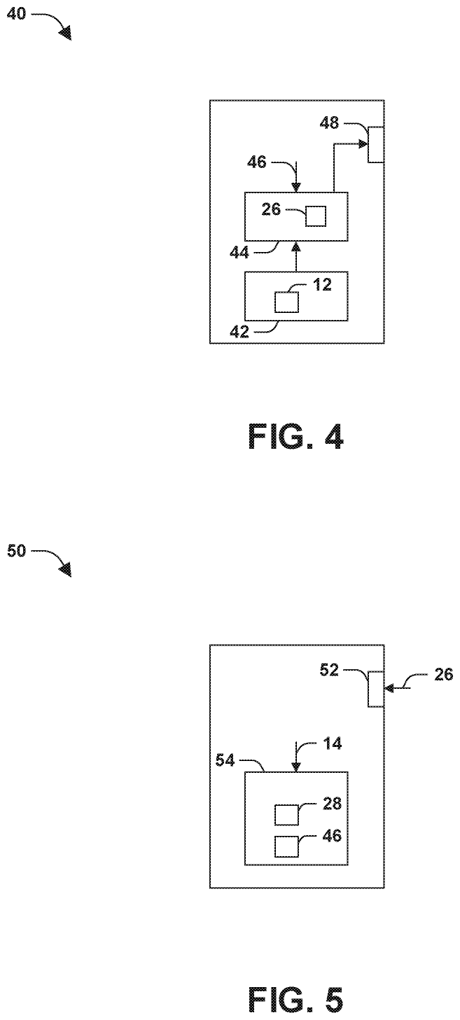

FIG. 4 shows a schematic block diagram of a device 40 according to an embodiment. The device 40 may be configured for operating as a cold wallet device of a blockchain. Although the cold wallet device may be designed so as to avoid access to larger networks such as the internet, the device 40 may, however, be configured for accessing the internet, for example, in a specific secured environment or the like. The device 40 may comprise a storage 42 configured for storing therein the master key 12. That is, the master key 12 may be stored in the data storage 42 which may be a volatile or non-volatile memory.

The device 40 may comprise a processor 44, for example, a central processing unit (CPU), an application specific integrated circuit (ASIC), a field programmable gate array (FPGA), a microcontroller or the like. The processor 44 may have access to the storage 42 and may be configured for signing a key value 46, e.g., the key 14, the public part 14′ respectively, with the master key 12 to obtain a master key-based signature of the key 46, e.g., information 26.

The device 40 may comprise a communication interface 48 configured for transmitting the master key-based signature to a communication partner.

The key value 46 may be received from the communication partner, for example, using the communication interface 48. Alternatively, the key value 46 may be generated by the device 40 itself, e.g., based on a request received by use of the communication interface 48. The device 40 may also be implemented to allow for both, receiving the key value 46 and for generating the key value 46, e.g., based on a specific requirement in a specific situation, e.g., to receive the key value 46 (e.g., once receive the key value 46) and to generate the key value 46 (e.g., once generate the key value 46).

The communication interface 48 may be configured for communicating with the communication partner via a wired connection and/or wirelessly communicating with the communication partner via a wireless connection. A wireless communication may include a short distance or a long distance communication such as RFID (radio frequency identification), NFC (nearfield communication), mobile networks or the like.

The storage 42 and/or the processor 44 may be part of a hardware-based root of trust and/or of a secure element.

FIG. 5 shows a schematic block diagram of a device 50. The device 50 may be configured for operating as a hot wallet device of a blockchain. Although the implementation as a hot wallet device may be understood as having access to the internet, hot wallet is not limited hereto. A hot wallet device may be understood as a device which is vulnerable to loss of the key which may, in one example, be true for portable or wearable tokens. The device 50 may comprise a communication interface 52 configured for receiving the information 26, i.e., a master key-based signature of the key value.

The device 50 comprises a processor 54 configured for generating a transaction of the blockchain using the associated key so as to generate the transaction 28 on behalf of the master key. The device is configured for transmitting the transaction 28 to the blockchain.

The communication interface 52 may be implemented corresponding to the communication interface 48 such that an exchange of information or signals between the devices 40 and 50 is implemented. The communication interface 52 may be configured for communicating with a communication partner (e.g., the device 40) via a wired connection and/or wirelessly communicating with the communication partner via a wireless connection. In some examples, the communication interface 52 may be a short distance communication device, such as a RFID device, a NFC device or the like.

In a scenario in which the device 50 may generate the key value 46 as a public key, it may transmit the key value 46 to the device 40. In such a scenario, when receiving the information 26, the key value is already known at the device 50. Alternatively, when device 40 generates the key value 46, the device 50 may receive the key value 46 from the device 40. For example, the device 50 may be configured for generating the key value 46, e.g., using the processor 54 or a different processor. The device 50 may be configured for transmitting the key value 46 to a communication partner, e.g., device 40, using the communication interface 52. The device 50 may be configured for receiving the master key-based signature of the associated key from the communication partner, the master key-based signature 26 being obtained by signing the key value with the master key.

That is, device 50 may be configured for receiving, using the communication interface 52, the master key-based signature of the associated key. Device 50 may include, into the transaction 28, a signature being obtained by use of the associated key 14 and the master key-based signature 26 as described in connection with FIGS. 2b and 2c.

Embodiments provide for a method in which the key value 46, the basis for the associated key 14 respectively is generated in the hot wallet device 50. Such a method comprises transmitting the key value to the cold wallet device that has access to the master key. The method comprises signing the key information using the cold wallet device and using the master key to obtain a master key-based signature of the key value, e.g., information 26. The method comprises transmitting the master key-based signature to the hot wallet device 50.

Embodiments further provide for a method in which the key value 46 is generated in the cold wallet device 40 which has access to the master key 12. The method comprises signing the key information using the cold wallet device 40 and using the master key 12 to obtain a master key-based signature. The method further comprises transmitting the key value 46 and the master key-based signature 26 to a hot wallet device. That is, when compared to a scenario in which the key value 46 is generated at the hot wallet device, when generating the value in the cold wallet device, the hot wallet device is additionally supplied with the key value.

As described, the device 50 may be configured for generating a key policy relating to a validity of the associated key and may transmit information indicating the policy to the communication partner. Alternatively, the key policy may be generated in or at the device 40 or may be omitted.

Device 50 may be implemented, for example, as an application in device 40 therefore using at least some of the hardware components of device 40. Alternatively, the application may also be executed on a different device.

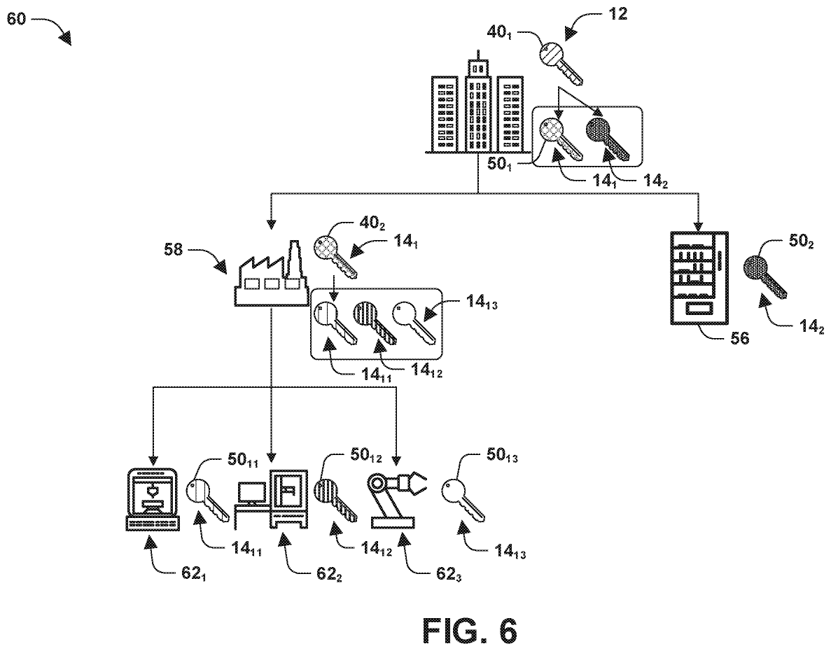

FIG. 6 shows a schematic block diagram of a blockchain system 60 according to an embodiment. The blockchain system comprises at least one device 40 and at least one device 50. By way of non-limiting example only, the blockchain system comprises the device 40₁ having stored thereon the master key 12. According to an embodiment, at least a second transaction of the blockchain may be generated using a further associated key 14₂ so as to generate the perspective transaction also on behalf of the master key 12. For example, one, two, three, four or even a higher number such as at least 5, at least 10, at least 20 or more associated keys 14₁ and 14₂ may be associated with the master key 12. Each associated key may be related to a key-individual, group-individual or global key policy.

For example, the associated keys 14₁ and 14₂ may be associated with different key policies, i.e., they may differ in view of the rights, permissions or the like enabled therewith. By way of non-limiting example, whilst associated key 14₂ may allow a device 50₂ having stored associated key 14₂ to perform payment, e.g., in an official or internal currency, e.g., at a snack vending machine 56 or any other terminal, associated key 14₁ being stored or available at device 40₂ may allow to enter an area of a site 58 and/or to activate, deactivate or manipulate objects or information therein or thereof.

For example, associated key 14₁ may allow to use, activate, deactivate or program machinery 62₁, 62₂ and/or 62₃ at site 58. Machinery 62₁ to 62₃ stands for any kind of actions that are restricted or to be documented within the blockchain and that relate to a hardware-based object or to a software-based object such as data.

For instance, the master key 12 may be used for endorsing one or more associated keys 14₁ and 14₂ to enable transactions (e.g., with same or different permissions being set in the key policy) such that the associated keys 14₁ and 14₂ both act on behalf of the master key.

An associated key, e.g., associated key 14₁ may be used to enable further associated keys. As the device 40₂ may be used to create more associated keys or keys associated with the associated key 14₁, in some embodiments device 40₂ may be implemented as a higher security wallet, e.g., a cold wallet device as described in connection with FIG. 4. Alternatively, the device 40₂ may be implemented as a hot wallet device as described in connection with FIG. 5. For example, when re-distributing keys or sub-associated keys face a low security level and/or when the permissions that are associated with or derived from the associated key 14₁ allow for a lower security level.

Generating associated keys from the associated key 14₁ may include using the associated key 14₁ as a master key for further, sub-associated keys 14₁₁, 14₁₂ and/or 14₁₃, wherein a number of sub-associated keys may be arbitrary and may be one or more, two or more, three or more, or even larger, e.g., at least 5, at least 10, at least 20 or even higher. In different terms, the associated key 14₁ may be used as a kind of master key itself.

A method in accordance with embodiments comprises endorsing a sub-associated key to allow signing transactions of the blockchain on behalf of the associated key. That is, as described for the relationship between the master key 12 and the associated key 14₁, sub-associated keys 14₁₁, 14₁₂ and/or 14₁₃ may allow to generate transactions on behalf of the associated key, thereby indirectly on behalf of the master key. The method comprises generating a transaction of the blockchain using the sub-associated key 14₁₁, 14₁₂, 14₁₃ respectively so as to generate the transaction on behalf of the master key and/or on behalf of the associated key.

According to an embodiment, permissions associated with sub-associated keys 14₁₁, 14₁₂ and 14₁₃ may, at most, be equal to the associated key 14₁ or may be narrower. This may be understood as using the associated key 14₁ as a master key or parent for further associated keys, the sub-associated keys 14₁₁, 14₁₂ and 14₁₃ which may, in some examples, be used (e.g., subsequently used) as further master keys.

An embodiment provides for a method that comprises invalidating the associated key 14₁ or 14₂ or a sub-associated key 14₁₁ to 14₁₃ endorsed by the associated key 14₁ responsive to a termination event. Embodiments provide for a method comprising determining a termination event related to the associated key 14 and invalidating the associated key in response to the termination event (whilst leaving the master key 12 valid, for example). That is, the master key 12 may be valid after the associated key 14 has been invalidated. A termination event may comprise, for example, a report that a device having stored the associated key 14₁ or a key derived therefrom (e.g., a sub-associated key) is lost, was hacked or is differently corrupted. Alternatively or additionally, a termination event may comprise a recognition within the blockchain system that an abuse of a key or rights associated therewith was attempted or has happened. For example, such an event may occur when a key policy is generated in connection with a sub-associated key that goes beyond the key policy being associated with the master key or the associated key. Alternatively or in addition, the termination event may comprise a scenario in which a counter that indicates a usability of the respective key has reached a minimum value (e.g., when decrementing at each use) or a maximum value (e.g., when counting the number of uses). Alternatively or in addition, a termination event may occur when a predefined life span of a key has been reached.

Although the cold wallet device 40 and the hot wallet device 50 are illustrated in connection with FIGS. 4 and 5 as two separate devices and are shown as different entities in FIG. 6, both devices may also be part of a common device. For example, the cold wallet device may form or be arranged in a secured environment of the common device whilst the hot wallet section has access to a network. The communication interfaces 48 and 52 may then be implemented as internal communication devices.

In other words, FIG. 6 shows a blockchain session key infrastructure.

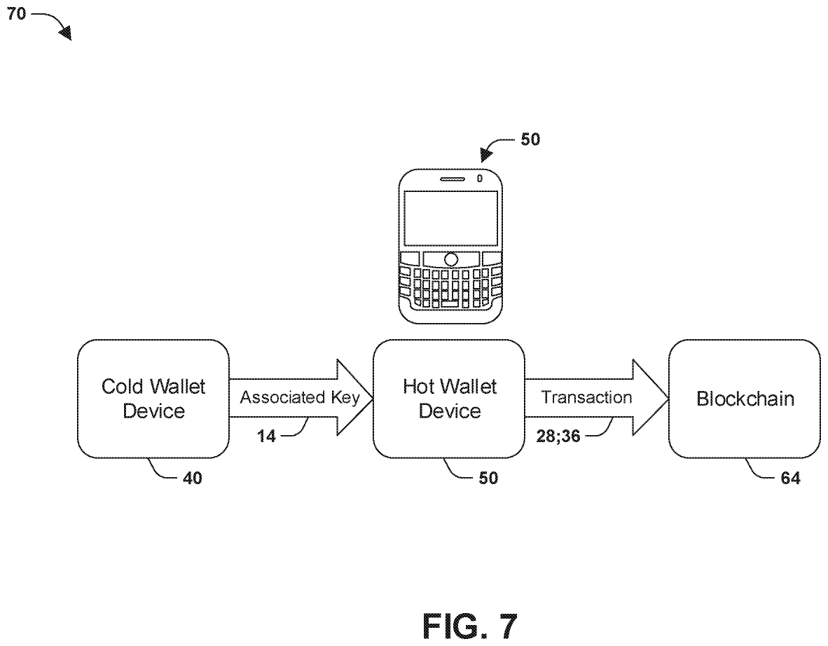

FIG. 7 shows a schematic block diagram illustrating a blockchain system according to an embodiment. The blockchain system comprises the device 40 and the device 50. The cold wallet device 40 may provide the associated key or session key 14 to the hot wallet device 50. The hot wallet device 50 may generate transaction 28, may sign it to obtain a signature, i.e., signed transaction 36, and may transmit transaction 28 and the signature 36 (and optionally additional information 38 in addition to the transaction 28 and the signature 36) to the blockchain 64 of which devices 40 and 50 are part. The blockchain 64 may be used to verify the transaction 28.

In other words, FIG. 7 shows an example in which the master key is stored in a NFC smartcard (cold wallet). For example, by tapping the NFC card behind a smartphone (enabling communication) a session key may be generated and stored in the phone application or embedded secure element (eSE) for better security. The session key may be used for all subsequent active transactions between the application and the blockchain.

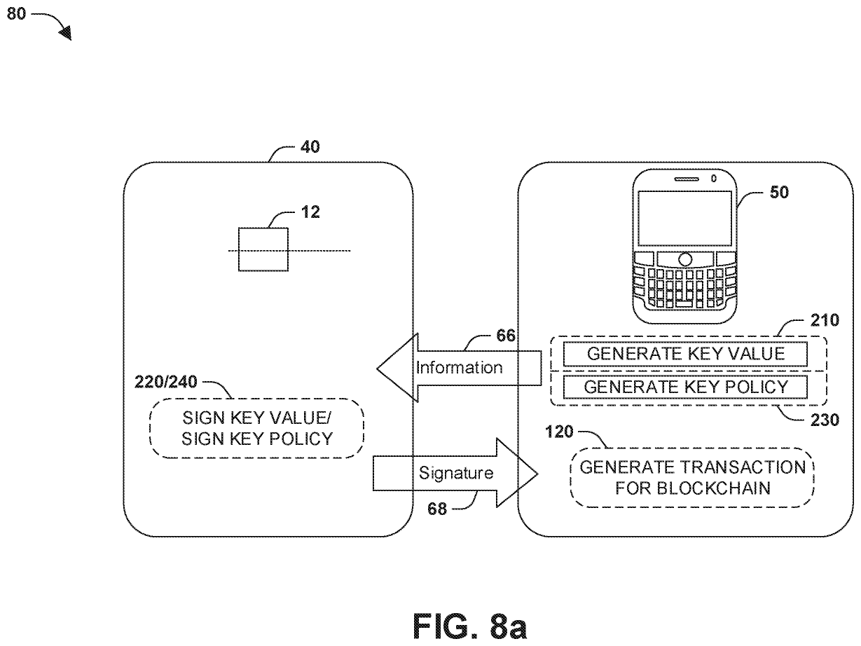

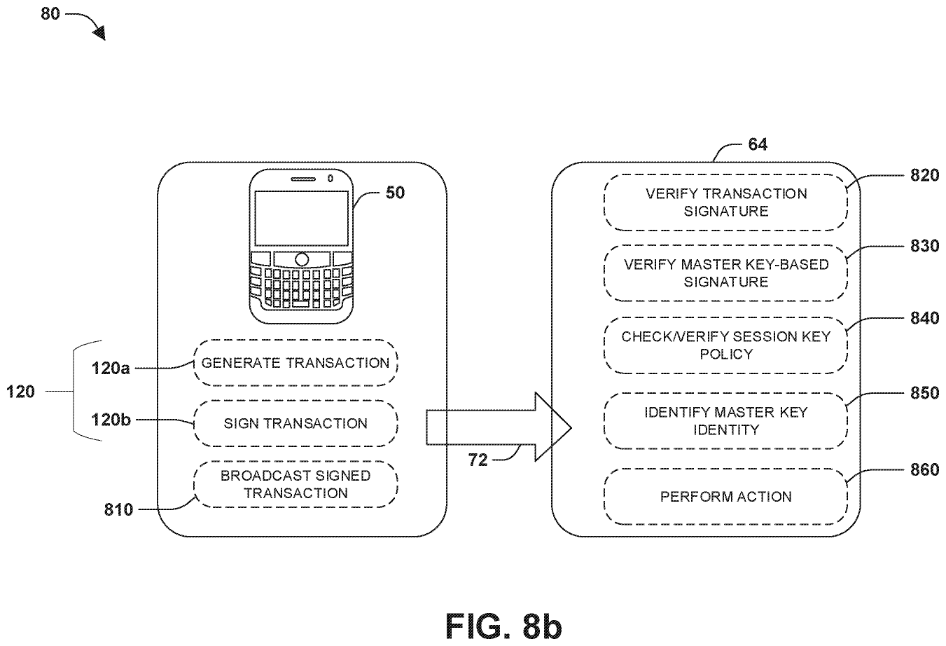

FIG. 8a shows a schematic block diagram of at least a part of a blockchain system 80 in which acts 210 and 230 to generate the session key and to generate the key policy are performed at the hot wallet device 50. This information (e.g., the session key and/or the key policy) is transmitted by use of a signal 66 to the cold wallet device 40 which has access to the master key 12. Acts 210 and/or 230 may alternatively be implemented in the device 40.

Device 40 signs the information (e.g., the session key and/or the key policy) received with signal 66, e.g., by use of communication interface 48, by combinedly performing acts 220 and 240. A signature obtained thereby is transmitted by use of a signal 68 to device 50 again, using communication interfaces 48 and 52. Device 50 may be configured for performing act 120, i.e., to generate a transaction. That is, device 50 may transact on behalf of the master key 12 whilst using the session key.

In other words, FIG. 8a shows the part of generating the blockchain session key.

FIG. 8b shows a schematic block diagram of another part of the blockchain system 80. Device 50 may generate a transaction in an act 120a and may sign the transaction using the associated key in an act 120b, thereby performing act 120. That is, in act 120 the obtained session signature is received. The device 50 may further implement an act 810 of a method according to an embodiment in which the signed transaction is broadcasted to the blockchain.

To broadcast 810 the transaction, a signal 72 may be transmitted, using the communication interface 52 or a different communication interface.

The blockchain 64 may perform an act 820 by verifying the transaction signature, i.e., the associated key-based signature. Further, an act 830 may be implemented in which the master key-based signature is verified, i.e., the information being signed by use of the master key. In an act 840, in some examples, the session key policy may be checked and/or verified. That is, acceptance of the transaction within the blockchain system may be based on a compliance of the transaction with the key policy. In an act 850, the master key identity may be identified, for example, by using the public key of the master being contained in the transaction being transmitted in signal 72.

In an act 860, the requested action indicated by the transaction may be performed on the master key's asset, i.e., on behalf of the master key. This act may depend on a verification that the master and the hot wallet device 50 are empowered to perform the action.

In other words, FIG. 8b shows a transaction flow using the session key, the part of a transaction by use of the blockchain session key respectively.

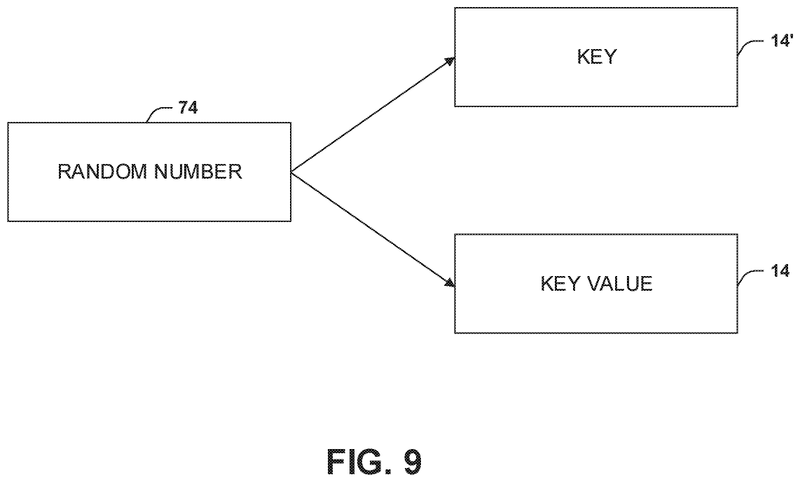

FIG. 9 shows a schematic block diagram illustrating a relationship between the key value 14 being, for example, a private key and the key 14′, being for example, an associated or corresponding public key. From a suitable seed or basis, i.e., a random number 74, both values may be derived using known concepts. Whilst the public key 14′ may be transmitted throughout the system, the private key 14 may remain unshared or secret. Signing of information may be performed by use of the private key 14 whilst informing other nodes about the public key 14′ so as to verify the identity of the signing node. The same may be implemented for the master key 12.

In other words, by using hardware security tokens such as hardware wallets, a reduced usability may be obtained since the user presence is checked, e.g., when pressing the token's button, and the token is required for every transaction. If the token falls in the hand of an adversary, the user's account may be compromised. Losing the token may also cause a permanent loss of the key. This disadvantage is overcome by the embodiments described herein allowing to use a temporary key or a key that acts on behalf of the master key such that the master key is not necessarily present when performing a transaction. Embodiments allow to obtain a balance between the usability and a security of blockchain key storage. Further, embodiments allow having a low impact of losing a hot wallet key.

Embodiments related to a delegation of authority by using a session key. Embodiments allow a creation of a session key which is tied to the master key. The session key may have a limited life span and/or a predetermined policy. The loss of a session key may result in limited or even no harm. The master key can be kept in safe custody since it is not needed frequently. According to embodiments, authority is delegated by use of session key. A session key may be generated and correlated to a user's master key. The session key holding entity can transact on behalf of the master key. Multiple sessions can be generated and used concurrently and/or sequentially. Every generated session key may have a unique value. The session key may have a life span and/or policy relating to one or more of:
asset based, valid until allocated asset depleted;
time based, valid for a period of time (e.g., block height);
transaction counter based, valid until counter depleted; and
scope of access, accessible assets.

The session key holder, i.e., the hot wallet device, may close or invalidate a session on exit, which may be a termination event. The master key holder can also invalidate its session key at any given time, for example, based on a termination event.

Embodiments allow to support systems that utilize the concept of both, hot and cold wallets.

Embodiments relate to a session key that is generated and correlated to a master key. The session key holder can transact on behalf of the master key. A session key policy may be programmable or selectable. This may allow to restrict the access of the associated key to a certain group of assets of the master key. The session key policy may also be related to a lifespan which may relate to being asset based and valid until the allocated asset is depleted, time based and valid for a period of time (block height), being transaction counter based and valid until the counter is depleted and/or to other conditions. The session key holder and/or the master key holder can terminate a session, that is, invalidate the associated key.

Embodiments allow to overcome the demotivation related with the use of a cold wallet. Access to known cold wallets may be inconvenient. A solution such as a contactless token may possibly not work conveniently with an application that requires numerous transactions (e.g., gaming, trading, social media, etc.). In view of machine-to-machine M2M automation, having the master key installed in the machine (hot wallet) is vulnerable to physical or logical attacks. Embodiments allow to bridge the gap of usability and security.

Although some aspects have been described in the context of an apparatus, it is clear that these aspects also represent a description of the corresponding method, where a block or device corresponds to a method act or a feature of a method act. Analogously, aspects described in the context of a method act also represent a description of a corresponding block or item or feature of a corresponding apparatus.

Depending on certain implementation requirements, embodiments of the present disclosure can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the present disclosure comprise a data carrier having electronically readable control signals, which are capable of cooperating with a programmable computer system, such that one of the methods described herein is performed.

Generally, embodiments of the present disclosure can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the present disclosure is, therefore, a computer program having a program code for performing one of the methods described herein, when the computer program runs on a computer.

A further embodiment of the present disclosure is, therefore, a data carrier (or a digital storage medium, or a computer-readable medium) comprising, recorded thereon, the computer program for performing one of the methods described herein.

A further embodiment of the present disclosure is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Any sequence of acts, actions, operations and/or steps is for illustrative purposes and not intended to be limiting on the present disclosure. A specific order of acts, actions, operations and/or steps may be rearranged while remaining within the scope of the present disclosure.

The above described embodiments are merely illustrative for the principles of the present disclosure. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

1. A method for signing a blockchain transaction, the method comprising:
associating an associated key with a master key of a blockchain; and
generating, on behalf of the master key, a transaction for the blockchain using the associated key.

2. The method of claim 1, comprising:
generating a key value; and
signing the key value using the master key to endorse the associated key.

3. The method of claim 2, comprising:
generating a key policy relating to a validity of the associated key, wherein a usability of the associated key in the blockchain is based on the key policy; and
signing the key policy using the master key.

4. The method of claim 2, wherein the signing the key value is performed in a cold wallet device, and wherein the generating the transaction is performed in a hot wallet device.

5. The method of claim 2, wherein the generating the key value is performed in a hot wallet device, the method comprising:
transmitting the key value to a cold wallet device having access to the master key, wherein the signing the key value using the master key is performed by signing key information, comprising the key value, using the cold wallet device and the master key to obtain a master key-based signature of the key value; and
transmitting the master key-based signature to the hot wallet device.

6. The method of claim 2, wherein the generating the key value is performed in a cold wallet device having access to the master key, and wherein the signing the key value using the master key is performed by signing key information, comprising the key value, using the cold wallet device and the master key to obtain a master key-based signature of the key value, the method comprising:
transmitting the key value and the master key-based signature to a hot wallet device.

7. The method of claim 1, wherein the generating the transaction comprises:
signing information using the associated key to obtain an associated key-based signature of the information;
signing a key value, related to the associated key, using the master key to obtain a master key-based signature; and
adding, to the associated key-based signature, the master key-based signature.

8. The method of claim 1, wherein the associated key is linked with a key policy relating to at least one of:
a selection of at least a subset of transactions supported by the master key; or
a lifespan of the associated key.

9. The method of claim 1, wherein the associated key is a first associated key, the method comprising:
endorsing a second associated key to enable transactions using the second associated key on behalf of the master key.

10. The method of claim 9, wherein the transaction is a first transaction, the method comprising:
generating, on behalf of the master key, a second transaction of the blockchain using the second associated key.

11. The method of claim 1, comprising:
endorsing a sub-associated key to allow signing transactions using the sub-associated key on behalf of the associated key; and
generating, on behalf of at least one of the master key or the associated key, a second transaction of the blockchain using the sub-associated key.

12. The method of claim 1, comprising:
invalidating at least one of the associated key or a sub-associated key endorsed by the associated key responsive to a termination event.

13. The method of claim 1, comprising:
determining a termination event related to the associated key; and
invalidating the associated key responsive to the termination event, wherein the master key is valid after the invalidating the associated key.

14. The method of claim 1, comprising:
verifying a signature of the transaction using a blockchain-system to verify that the transaction was signed by use of the associated key;
verifying a signature of the associated key to verify that the associated key was signed by use of the master key; and
responsive to successful verification of the signature of the associated key, accepting the transaction as being made on behalf of the master key or a device associated with the master key.

15. The method of claim 14, comprising:
analyzing the transaction to determine a key policy associated with the associated key; and
verifying the transaction with respect to a compliance with the key policy.

16. The method of claim 1, wherein the associated key is a session key.

17. A device configured to operate as a hot wallet device of a blockchain, the device comprising:
a communication interface configured to receive a master key-based signature of an associated key associated with a master key of the blockchain; and
a processor configured to generate, on behalf of the master key, a transaction of the blockchain using the associated key, wherein the device is configured to transmit the transaction to the blockchain.

18. The device of claim 17, wherein the device is configured to include, into the transaction, a signature obtained using the associated key and the master key-based signature.

19. The device of claim 17, wherein the communication interface is a short distance communication device.

20. The device of claim 17, wherein the device is configured to:
generate a key value; and
transmit the key value to a communication partner using the communication interface; and
receive the master key-based signature of the associated key from the communication partner, wherein the master key-based signature is obtained by signing the key value with the master key.

21. The device of claim 20, wherein the device is configured to:
generate a key policy relating to a validity of the associated key; and
transmit information indicating the key policy to the communication partner.

22. A device configured to operate as a cold wallet device of a blockchain, the device comprising:
a storage configured to store a master key of the blockchain;
a processor configured to sign a key value with the master key to obtain a master key-based signature of the key value; and
a communication interface configured to transmit the master key-based signature to a communication partner.

23. The device of claim 22, wherein the device is configured to receive the key value using the communication interface or to generate the key value based on a request received using the communication interface.

24. The device of claim 22, wherein at least one of the storage or the processor is part of a hardware-based root of trust.

25. A blockchain system comprising one or more master key apparatuses comprising a master key apparatus comprising the device of claim 22, the blockchain system comprising:
one or more agent apparatuses, wherein an agent apparatus of the one or more agent apparatuses comprises:
a second communication interface configured to receive the master key-based signature of an associated key associated with the master key of the blockchain; and
a second processor configured to generate, on behalf of the master key, a transaction of the blockchain using the associated key, wherein the agent apparatus is configured to transmit the transaction to the blockchain.

26. The blockchain system of claim 25, wherein the agent apparatus and the master key apparatus are part of a same device.
